(19) United States
(12) Patent Application Publication
(10) Pub. No.: US 2012/0223840 A1
(43) Pub. Date: Sep. 6, 2012

(54) SMART GRID OVER POWER LINE COMMUNICATION NETWORK

(75) Inventors: Mark Guymon, San Diego, CA (US); Kenneth J. Brown, Chula Vista, CA (US); Carlos Ramirez, San Diego, CA (US)

(73) Assignee: Leviton Manufacturing Co., In., Melville (NY)

(21) Appl. No.: 13/321,842

(22) PCT Filed: Jun. 4, 2010
(86) PCT No.: PCT/US10/37464

§ 371 Date: May 23, 2012

Related U.S. Application Data
(60) Provisional application No. 61/184,347, filed on Jun. 5, 2009.

(51) Int. Cl. G08C 19/00

(52) U.S. Cl. 340/870.02

(57) ABSTRACT

A smart-grid communication system including a plurality of receptacles and a power management gateway in electrical communication with each of the plurality of receptacles is presented. Each of the power modules of the plurality of receptacles provides power usage information to the power management gateway. Also, the power usage information is transmitted via a first communication means to the power management gateway and the power management gateway transmits the information via a second communication means to one or more external communications sources.

### CROSS-REFERENCE TO RELATED APPLICATIONS

The present application claims priority from U.S. Provisional Patent Application No. 61/184,347 filed Jun. 5, 2009, the contents of which are incorporated herein by reference in their entirety.

### BACKGROUND

1. Field of the Related Art

The present disclosure relates to energy consumption metering, and more particularly, to a method and system for enabling a plurality of metered receptacles to communicate power usage information to one or more power management gateways.

2. Background of the Related Art

Electric power transmission is the bulk transfer of electricity to consumers. A power transmission network typically connects power plants to multiple substations near a populated area. Such a power transmission network may be usually referred to as a “grid.” Multiple redundant lines between points on the network are provided so that power may be routed from any power plant to any load center, through a variety of routes, based on the economics of the transmission path and the cost of power. Electricity generation stations throughout the United States are interconnected in a system called “power grids.” This allows electricity generated in one region to be sent to users in another region. It also allows distant power generation stations to provide electricity for cities and towns.

In the U.S. electrical system, there are more than 6,000 power generating units. Power from these stations is moved around the country through bulk transmission lines. The power transmission is directed by more than 100 control centers, where the power is monitored and routed from areas of low demand to areas of high demand. Consumers typically access the electricity via power outlets incorporated in electrical receptacles positioned throughout homes and offices; e.g., installed on/in walls, ceilings, floors, or the like. As a result, in the electric power industry, power is typically supplied to customers in a multi-stage process of generation, transmission, distribution, and end use (by consumers via power outlets).

Thus, every home, office, modern building structure or the like has a plurality of outlet receptacles for receiving electricity from a distant power plant. The most common type of outlet receptacle is the duplex outlet receptacle. Additionally, popular duplex outlet receptacles include ground fault circuit interrupter (GFCI) outlets, surge protective outlets, or the like.

The power utility industry is transitioning from a passive system linking generation to load to a true interactive digital network with full connectivity and interoperability from energy generation management to the end customer energy use. This full-capability, network-based utility infrastructure has been referred to as a smart-grid. The network supporting the two-way, dynamic information flow is often referred to as the smart-grid network. The term smart grid network may refer to a utility network. Once implemented, the smart-grid network may also support auxiliary networks and devices like the in-premise networks that monitor and control in-home appliances and facilities.

A smart grid system delivers electricity from suppliers to consumers using digital technology to save energy, reduce cost, and increase reliability. An electricity grid is typically not managed by a single entity but instead by an aggregate of multiple networks and multiple power generation companies with multiple operators employing varying levels of communication and coordination, most of which is manually controlled. Smart grids increase the connectivity, automation and coordination between these suppliers, consumers and networks that perform either long distance transmission or local distribution tasks.

Smart-grid compatible devices need to be developed to take advantage of the smart grid power network. Moreover, due to recent concerns about excess electricity consumption and how to reduce it, it would be advantageous to measure, monitor, and control consumption at the point of use, in other words, at the receptacles located within homes, offices, and/or modern building structures or the like in order to fully realize the potential of smart grid systems/networks. Thus, an electrical receptacle incorporating smart grid compatible components/circuitry having monitoring and controlling capabilities for effectively connecting to a smart grid system/network would be highly desirable.

### SUMMARY

Objects and advantages of the present disclosure will be set forth in the following description, or may be obvious from the description, or may be learned through practice of the present disclosure.

The present disclosure provides a smart-grid communication system including a plurality of receptacles and one or more power management gateways in electrical communication with each of the plurality of receptacles. Each of the plurality of receptacles provides power usage information to the one or more power management gateways.

The present disclosure provides a smart-grid communication system including a plurality of receptacles each configured to include a power module and one or more power management gateways in bidirectional communication with the plurality of receptacles. Each of the plurality of receptacles is configured to collect, analyze, and communicate real-time or periodic energy consumption information to the one or more power management gateways.

The present disclosure provides a method for measuring energy consumption at a point of use, including performing one or more programming instructions via a tangible processor for associating each of a plurality of receptacles with a power module and enabling bidirectional communication between one or more power management gateways and the plurality of receptacles. Each of the plurality of receptacles is configured to collect, analyze, and communicate real-time or periodic energy consumption information to the one or more power management gateways.

The present disclosure provides a system for measuring energy consumption at a point of use, including a processor and a computer-readable storage medium in communication with the processor, the computer-readable storage medium comprising one or more programming instructions for associating each of a plurality of receptacles with a power module and enabling bidirectional communication between one or more power management gateways and the plurality of receptacles. Each of the plurality of receptacles is configured to collect, analyze, and communicate real-time or periodic energy consumption information to the one or more power management gateways.

The present disclosure further provides for a meter unit and at least one sensor for measuring current and voltage. The meter unit of each of the receptacle is configured to collect, analyze, and communicate energy consumption information to one or more power management gateways.

Additional objects and advantages of the present disclosure are set forth in, or will be apparent to those skilled in the art from, the detailed description herein. Also, it should be further appreciated that modifications and variations to the specifically illustrated, referenced, and discussed steps, or features hereof may be practiced in various uses and embodiments of the present disclosure without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of the present disclosure may include various combinations or configurations of presently disclosed features or elements, or their equivalents (including combinations of features or parts or configurations thereof not expressly shown in the figures or stated in the detailed description).

### BRIEF DESCRIPTION OF THE DRAWINGS

The foregoing and other objects, features, and advantages of the present disclosure will be apparent from the following more particular description of preferred embodiments as illustrated in the accompanying drawings, in which reference characters refer to the same parts throughout the various views. The drawings are not necessarily to scale, emphasis instead being placed upon illustrating principles of the present disclosure.

Various embodiments of the present disclosure will be described herein below with reference to the figures wherein:

FIG. 1 is a schematic diagram of a smart-grid power system, in accordance with the present disclosure;

FIG. 2 is a schematic diagram of a smart-grid power system in communication with an external hub, in accordance with the present disclosure;

FIG. 3 is a schematic diagram of a smart-grid power system including groups of receptacles, in accordance with a second embodiment of the present disclosure;

FIG. 4 is a schematic diagram of a smart-grid power system including groups of receptacles and an external hub, in accordance with the second embodiment of the present disclosure;

FIG. 5 is a schematic diagram of a smart-grid power system where each of the plurality of receptacles is directly connected to a single power management gateway, in accordance with a third embodiment of the present disclosure;

FIG. 6 is a schematic diagram of a smart-grid power system where groups of receptacles are each connected to separate power management gateways for communication with a central power management gateway, in accordance with the present disclosure;

FIG. 7 is a schematic diagram of a smart-grid communication system including a converter positioned between the power management gateway and one or more external networks, in accordance with the present disclosure;

FIG. 8 is a schematic diagram of a smart-grid communication system including a plurality of converters positioned adjacent to each of the plurality of receptacles, in accordance with the present disclosure;

FIG. 9 is a schematic diagram of a metered receptacle including a power sensor, a voltage sensor, and a microprocessor for communication with a power management gateway, in accordance with the present disclosure;

FIG. 10 is a schematic diagram of a metered receptacle including a power sensor, a voltage sensor, a microprocessor, a display screen, and a notification means for communication with a power management gateway, in accordance with the present disclosure;

FIG. 11 is a schematic diagram of a display screen of a power management gateway illustrating receptacle power usage, in accordance with the present disclosure;

FIG. 12 is a schematic diagram of a 3-D view of a metered receptacle, in accordance with the present disclosure;

FIG. 13 is a schematic diagram of a smart-grid power system including a power management gateway for managing and controlling one or more metered receptacles, in accordance with the present disclosure;

FIG. 14 is a schematic diagram of a metered wireless circuit incorporated with the one or more metered receptacles, in accordance with the present disclosure; and

FIG. 15 is a state diagram of the wireless metered receptacles, in accordance with the present disclosure.

While the above-identified drawing figures set forth alternative embodiments, other embodiments of the present disclosure are also contemplated, as noted in the discussion. In all cases, this disclosure presents illustrated embodiments by way of representation and not limitation. Numerous other modifications and embodiments may be devised by those skilled in the art which fall within the scope and spirit of the principles of the present disclosure.

### DETAILED DESCRIPTION

The present disclosure proposes a power monitoring and control system located at each receptacle of a home or office or building structure or the like. Due to recent concerns related to excess electricity consumption and how to reduce it, it has been decided that it would be advantageous to be able to measure/monitor/control the electricity consumption all the way to the point of use, in this case the receptacles, switches, and strips where all of the standard electrical devices are plugged into in order to make smarter decisions about energy use. All metered receptacles may create a network and the information generated by each one may be transmitted to a “master” device (i.e., a power management gateway) by using the power line carrier (PLC) communication capabilities built in the metered receptacle.

The present disclosure further proposes collecting data of the energy consumed by every power outlet/receptacle. For every socket, a power meter circuit may calculate power consumed by the device(s) connected to power outlet and send it to a server over a powerline. The user may then determine the total energy consumed and also energy consumed by individual outlets/receptacles.

The present disclosure further proposes metered receptacle devices that may not display any data or information, may look the same, and be connected the same as regular non-meter devices, wherein the data is sent via the installed wiring via PLC to a master device, such as a power management gateway, which may be used to review the data for all meter receptacle devices at the same time. However, it is contemplated that the metered receptacles could include a display device to inform a user of power usage at each metered receptacle.

The present disclosure further proposes two separate devices: a) one or more metered receptacle devices with communication capabilities and b) one or more master devices, which gather/accumulate/collect and display all the data/information.

The metered receptacle devices with communication capabilities are: a) receptacles and switches that fit in a standard single gang electrical wall box and b) strips that have more than two electrical outlets. The metered receptacle devices look the same as standard non-meter devices but they feature at least a current sensor, a voltage sensor, and a microprocessor to perform all the necessary calculation to measure, at least, the following items: the voltage present in the AC line, the AC current (amperage) that the load is consuming, the wattage (real power) that the load is consuming, the Volts-Amperes (apparent power) that the load is consuming, the power factor, and/or the kilowatt-hours that the load is consuming.

The microprocessor features a power line communication (PLC) transceiver that allows the system to transmit and receive digital information through the AC power wires. Additionally, once several power devices are connected they may form one or more smart grid communications networks.

The power management gateway may be connected to the same AC power wires as well and may gather/accumulate/collect the information/data that the metered receptacle devices send via the PLC. The data may be saved in the master device (i.e., power management gateway) with a time stamp. The master device may feature a display where, at least, the following data may be displayed: voltage at each device, total current (amperage) used by all the devices or by a particular device, total wattage (real power) used by all the devices or by a particular device, total Volts-Amperes (apparent power) used by all devices or by a particular device, total power factor or by device, total Kilowatt-hours used by all devices or by a particular device, and/or cost of electrical energy used based on user's electrical bill rate.

Additionally, the master device may also feature a universal serial bus (USB) connector, so that it may be connected to a computer/computing means to have enhanced displaying and storage capabilities. The master device could also include Ethernet connectivity with a built-in web server.

For the purposes of this disclosure, a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which may be used to store the desired information and which may be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module may include sub-modules. Software components of a module may be stored on a computer readable medium. Modules may be integral to one or more servers, or be loaded and executed by one or more servers. One or more modules may be grouped into an engine or an application.

“Power services” as used herein, may refer to energy delivery as well as other ancillary services including demand response, regulation, spinning reserves, non-spinning reserves, energy imbalance, and similar products.

“Power grid operator” as used herein, refers to the entity that is responsible for maintaining the operation and stability of the power grid within or across an electric control area. The power grid operator may constitute some combination of manual/human action/intervention and automated processes controlling generation signals in response to system sensors.

“Power grid” as used herein means a power distribution system/network that connects producers of power with consumers of power. The network may include generators, transformers, interconnects, switching stations, and safety equipment as part of either/both the transmission system (i.e., bulk power) or the distribution system (i.e., retail power).

“Grid conditions” as used herein, means the need for more or less power flowing in or out of a section of the electric power grid, in a response to one of a number of conditions, for example supply changes, demand changes, contingencies and failures, ramping events, etc. These grid conditions typically manifest themselves as power quality events such as under- or over-voltage events and under- or over-frequency events.

The term “analyze” may refer to determining the elements or essential features or functions or processes of the one or more metered receptacles for computational processing and/or power processing. The term “analyze” may further refer to tracking data and/or collecting data and/or manipulating data and/or examining data and/or updating data on a real-time basis or a periodic basis in an automatic manner and/or a selective manner and/or manual manner.

The term “electronic device” may refer to one or more personal computers (PCs), a standalone printer, a standalone scanner, a mobile phone, an MP3 player, audio electronics, video electronics, GPS systems, power monitoring devices, power controlling devices, power manipulating devices, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may refer to any type of electronics suitable for use with a circuit board and intended to be used by a plurality of individuals for a variety of purposes. The electronic device may be any type of computing and/or processing device.

Embodiments will be described below while referencing the accompanying figures. The accompanying figures are merely examples and are not intended to limit the scope of the present disclosure.

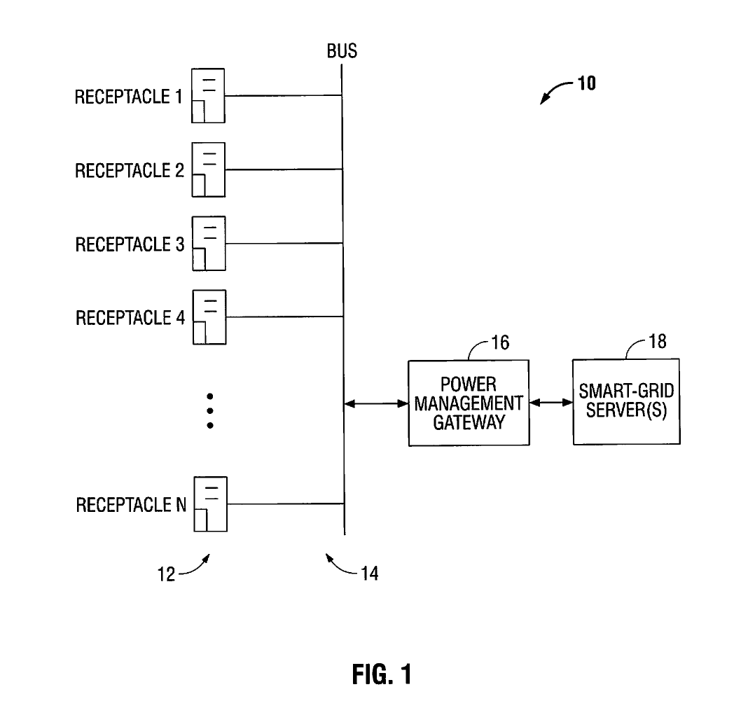

With reference to FIG. 1, there is presented a schematic diagram of a smart-grid power system, in accordance with the present disclosure.

The smart grid power system 10 includes a plurality of receptacles 12, a bus 14, a power management gateway 16 and a smart grid server(s) 18.

In a first exemplary embodiment, the plurality of receptacles 12 are connected to a power management gateway 16 via a bus 14. The power management gateway 16 may be further connected to a smart-grid server 18. Bi-directional communication is established between the plurality of receptacles 12, the bus 14, the power management gateway 16, and the smart-grid server(s) 18.

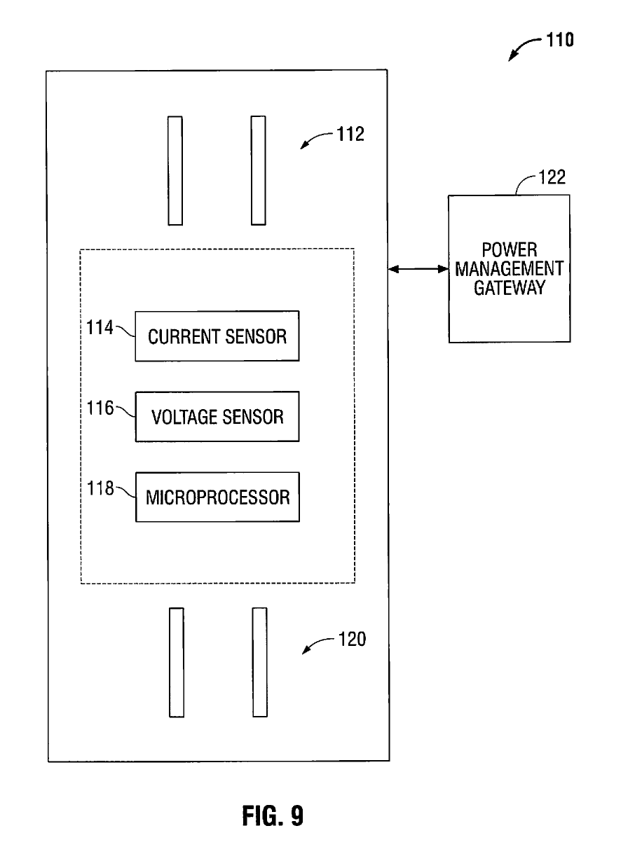

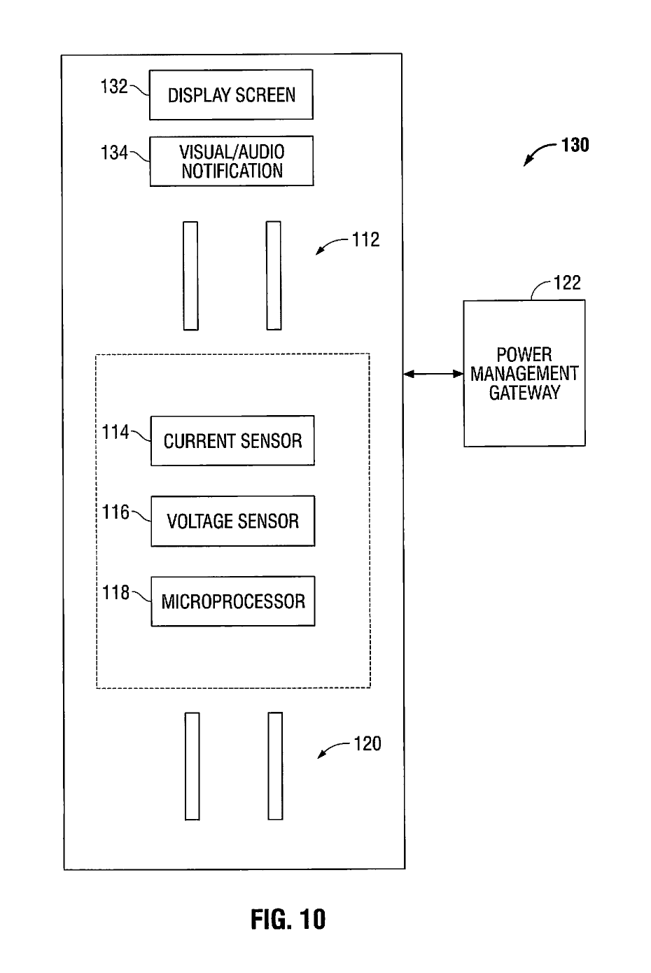

The plurality of receptacles 12 may be duplex receptacles. However, the plurality of receptacles 12 may be any type of receptacles contemplated by one skilled in the art. The plurality of receptacles 12 may look the same as standard non-meter devices but they feature at least a current sensor, a voltage sensor, and a microprocessor (described below with reference to FIGS. 9 and 10) to perform all the necessary calculation to measure, at least, the following items: the voltage present in the AC line, the AC current (amperage) that the load is consuming, the wattage (real power) that the load is consuming, the Volts-Amperes (apparent power) that the load is consuming, the power factor, and/or the kilowatt-hours that the load is consuming.

The power management gateway 16 may be any type of computing means or any type of portable or non-portable wireless or non-wireless communicator. Handheld wireless communicators may include cell phones, smart phones that may include voice, video, text message, email and Web access capabilities, Personal Digital Assistants (PDA) with wireless communications capabilities, wireless pagers, wireless handheld email devices, and Personal Computers (PCs). Additionally, in the exemplary embodiments, the power management gateway 16 (e.g., portable communication facility) may be a cell phone, mobile phone, walkie talkie, satellite phone, PDA, web device, device, email device, web browsing facility, communication facility, navigation facility, information facility or other facility used for mobile and or portable communication.

The power management gateway 16 may feature a display where, at least, the following data may be displayed: voltage at each device, total current (amperage) used by all the devices or by a particular device, total wattage (real power) used by all the devices or by a particular device, total Volts-Amperes (apparent power) used by all devices or by a particular device, total power factor or by device, total Kilowatt-hours used by all devices or by a particular device, and/or cost of electrical energy used based on user's electrical bill rate.

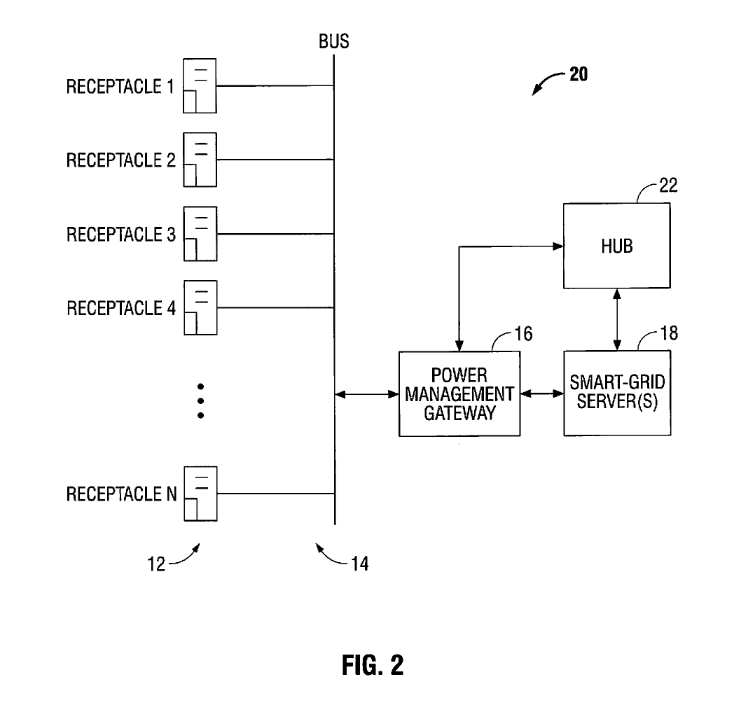

The smart-grid server 18 may refer to any type of smart networks for connecting smart devices that include one or more smart servers. In other words, the smart-grid server 18 may be used to provide access to a smart network interface and function as a gateway to external host computers (described below with reference to FIG. 2). A smart grid server 18 may refer to any type of network that is not passive, which contains built-in diagnostics, management, fault tolerance and other capabilities that keep it running smoothly. The smart grid server 18 may be designed to electrically communicate with one or more smart grid power systems/networks.

Moreover, the plurality of receptacles 12 of the smart-grid power system 10 may be part of a wireless network, which may have more than one power management gateway(s) 16. The power management gateway 16 may connect the wireless network nodes to one or more smart-grid servers 18. There may be more than one WAN and/or LAN and more than one server 18. There may be other wireless networks in the smart-grid network providing remote monitoring and control of other components of the smart-grid power system 10. The plurality of receptacles 12 in these wireless networks are in two-way communications with the smart-grid server(s) 18 via one or more power management gateways 16. Standard routers, bridges and other network interfaces may be used to connect the gateway 16 with the smart-grid server 18. Unless otherwise noted, the terms gateway and access point or point of access are to be considered interchangeable.

Furthermore, the plurality of receptacles 12 collect large volumes of data/information, convert the large volumes of data/information to small data volume information/data, and communicate the data/information to a larger information system to provide a system that is practical and scalable to large numbers of customers. The plurality of receptacles 12, in one embodiment, form part of an intelligent billing/monitoring/controlling system that allows obtaining real-time or periodic information related to power services and allows for an authorized power grid operator to control operations. Smart grid power system 10 offers the advantages of being able to individually address each power outlet/receptacle, hence allowing remote diagnostics by one or more authorized administrators and/or power grid operators.

The plurality of receptacles 12 may further serve multiple functions, such as, but not limited to: data collection (gathers real-time data and stores historical data), projections via a prediction engine, which inputs real-time data or periodic data, historical data, etc., outputs resource availability forecasts, optimizations built on resource availability forecasts, constraints, such as command signals from grid operators, user preferences, remote access capabilities, etc. The plurality of receptacles 12 may also each include a power module for communicating with the power management gateway 16.

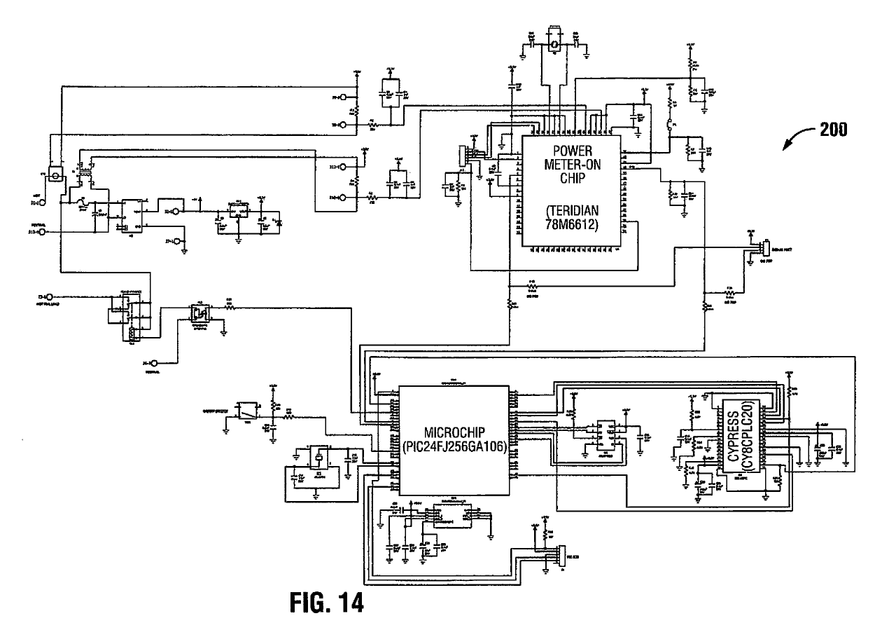

The plurality of receptacles 12 may each include a Wi-Fi microcircuit, as will be described in detail below with reference to FIG. 14. The Wi-Fi microcircuit may be associated with or be in operable communication with or be used in conjunction with the plurality of receptacles 12. The Wi-Fi microcircuit may be incorporated within the power module. The Wi-Fi microcircuit may be a low power unit used for transmitting the data/information collected and/or analyzed by the plurality of receptacles 12 to a plurality of electronic devices. The plurality of electronic devices may include, for example, personal computers (PCs) with wireless capabilities. Once the data/information collected and/or analyzed is sent/transmitted/communicated to the electronic devices, the electronic devices may transmit one or more commands to the plurality of receptacles 12. The plurality of receptacles 12 may receive the commands and engage in one or more actions. These actions may include, for example, turning off devices connected to one or more of the plurality of receptacles 12 and/or disconnecting/disabling one or more of the plurality of receptacles 12. Actions may also include providing additional power to the one or more receptacles 12 and/or limiting power transmitted to the one or more receptacles 12. Actions may also include providing external power (e.g., supplemental or substituted power) from one or more external power sources connected to the smart-grid communication system (e.g., from wind power, solar power, etc.). Therefore, the one or more electronic devices may wirelessly transmit one or more commands to either the plurality of receptacles 12 and/or to one or more power management gateways 16, 40, 64, 80, 82, 84 as described herein to at least monitor/track, control, manipulate, and/or update power/energy consumption data/information in real-time or periodically, either manually or automatically.

The plurality of receptacles 12 may use smart energy systems developed by any suitable company. Smart energy systems may be used to transmit/send/communicate information/data (e.g., power data) to the one or more electronic devices via the Wi-Fi circuit described above. For example, one such system may be the ZigBee Smart Energy System 1.0/2.0 that may be used in cooperation with the plurality of receptacles 12. Smart Energy 2.0 is an alliance between ZigBee and HomePlug™ to convey data/information throughout a residence and/or a commercial facility. The plurality of receptacles 12 may be hardwired receptacles or may be plug-in style receptacles for use in a smart grid to lower energy/power consumption. The plurality of receptacles 12 (e.g., both hardwired and plug-in) may each include the metered wireless Wi-Fi microcircuit, as described above. The plurality of receptacles 12 may be considered revenue grade meters. The revenue grade meter may be monitored with either Wi-Fi or with the Smart Energy systems described above. In one embodiment, the revenue grade meter may be designed to achieve “revenue grade” accuracy. Such “revenue grade” accuracy may be, for example, within 0.2% accuracy in accordance with ANSI 12.20.

Preferably, the plurality of receptacles 12 do not include a display means. The display means may be located at a remote location. For example, the display means may be located in a remote PC or a remote power monitoring device. Also, the power management gateway 16 may include a display means. The display means aids an operator to remotely view and/or manipulate and/or alter the data/information collected and/or analyzed by the plurality of receptacles 12.

Additionally, a scheduling function may be enacted within the smart grid power system 10 to enable a number of useful energy services and/or power services, including, but not limited to: ancillary services, such as rapid response services and fast regulation, energy to compensate for sudden, foreseeable, or unexpected grid imbalances, response to routine and unstable demands, and/or firming of renewable energy sources (e.g., complementing generation of other alternative energy sources, such as wind or solar power).

Although FIG. 1 illustrates the plurality of receptacles 12 as being connected to the bus 14 and power management gateway 16 by cables, it may be preferable to construct system 10 by using wireless technology. Example wireless technologies include, but are not limited to, cell phone, RF, and Personal Area Network. Regardless of the manner in which connections are achieved between the plurality of receptacles 12, the bus 14, and the power management gateway 16, all smart grid modules may be configured for serial data communication between the interconnected devices. However, alternative date transfer schemes may be used.

With reference to FIG. 2, there is presented a schematic diagram of a smart-grid power system in communication with an external hub, in accordance with the present disclosure.

The smart grid power system 20 includes a plurality of receptacles 12, a bus 14, a power management gateway 16, a smart grid server(s) 18, and an external hub 22. Smart grid power system 20 is substantially similar to smart grid power system 10 and thus will only be discussed further herein to the extent necessary to describe differences in the construction and use thereof.

The smart grid power system 20 further includes a hub 22, in contrast to the smart grid power system 10 of FIG. 1. The hub 22 may be a common connection point for devices in a smart grid network. Hub 22 may be used in cooperation with a LAN or WAN, and may include multiple ports. When a packet arrives at one port, it is copied to the other ports so that all segments of the LAN or WAN may see all packets. Hub 22 is preferably a smart hub or intelligent hub, in that, hub 22 includes additional features that enable an administrator to monitor the traffic passing through the hub and to configure each port in the hub. Intelligent hubs may also be referred to as manageable hubs. Alternatively, one skilled in the art may use a switching hub as well. It is to be understood that any type of device having multiple network interfaces and supporting a suitable connectivity may be used, non-limiting examples of which include shared hubs, switches (switched hubs), routers, and gateways. Hence, the term “hub” herein denotes any such device without limitation. Furthermore, the network may be any packet-based network, either in-building or distributed, such as a LAN, WAN or the Internet.

The hub 22 may be a hub owned, managed, and/or operated by an entity. Such an entity may act as an intermediary between the power management gateway 16 and the smart-grid server(s) 18. Such an entity may be any type of service provider. A service provider may be any entity that develops, offers, controls, manages, owns, alters and/or sells software and/or hardware products, such as receptacles. A service provider may be any entity that performs one or more tasks on one or more receptacles, which may or may not be controlled or owned by the service provider. For example, the entity may offer a service with an existing software package and/or with any type of existing Internet-based service through the Internet. In other words, a service provider need not own or provide the receptacles. The receptacles may be owned or provided by any third party not related or associated with the service provider. In the present disclosure, it is contemplated that the entity (such as a service provider) may offer any type of service and/or product by referring potential customers to an Internet website or a store that may or may not be associated with metered receptacle services and/or products. The term “entity” may refer to anything that may exist as a discrete and/or distinct unit that owns, operates, manages, and/or controls one or more of a plurality of machines (such as metered receptacles). For example, the term “entity” may include the term “company.”

As a result, a service provider may act as a conduit between the power management gateway 16 and the smart grid server(s) 18 in order to provide support and/or maintenance services and/or billing services related to the plurality of receptacles 12.

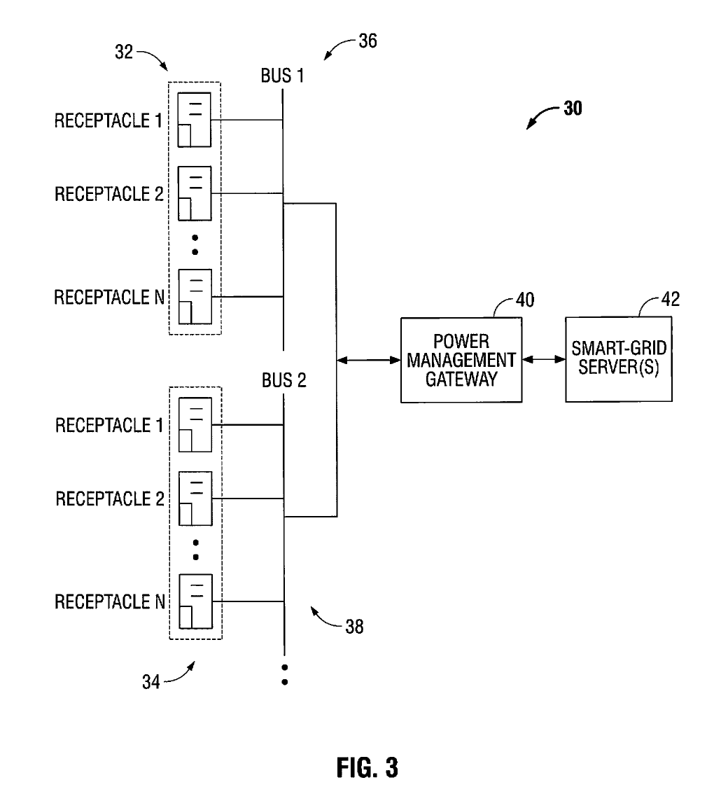

With reference to FIG. 3, there is presented a schematic diagram of a smart-grid power system including groups of receptacles, in accordance with a second embodiment of the present disclosure.

The smart-grid power system 30 includes a first group of receptacles 32 connected to a first bus 36, a second group of receptacles 34 connected to a second bus 38, a power management gateway 40, and a smart grid server 42. Smart grid power system 30 is similar to smart grid power system 10 and thus will only be discussed further herein to the extent necessary to describe differences in the construction and use thereof.

In this alternative exemplary embodiment, the receptacles may be grouped together. In other words, the first group of receptacles 32 may be permitted to access a first bus 36, whereas the second group of receptacles 34 may be permitted to access a second bus 36. Alternatively, a plurality of groups of receptacles may be provided, each group accessing a different bus, where all the buses connect to a main point of access, such as the power management gateway 40.

Such a configuration/implementation may be advantageous in a multi-level building structure, where, for example, a plurality of receptacles on each floor access a separate bus, and the separate buses connect to each other to transfer the data/information to a power management gateway. Additionally, such configuration/implementation may be advantageous in a home, where, for example, a plurality of receptacles in each room access a separate bus, and the separate buses connect to each other to transfer the data/information to a power management gateway. One skilled in the art may envision a number of different configurations/implementations where it would be advantageous to group a plurality of receptacles based on a number of criteria.

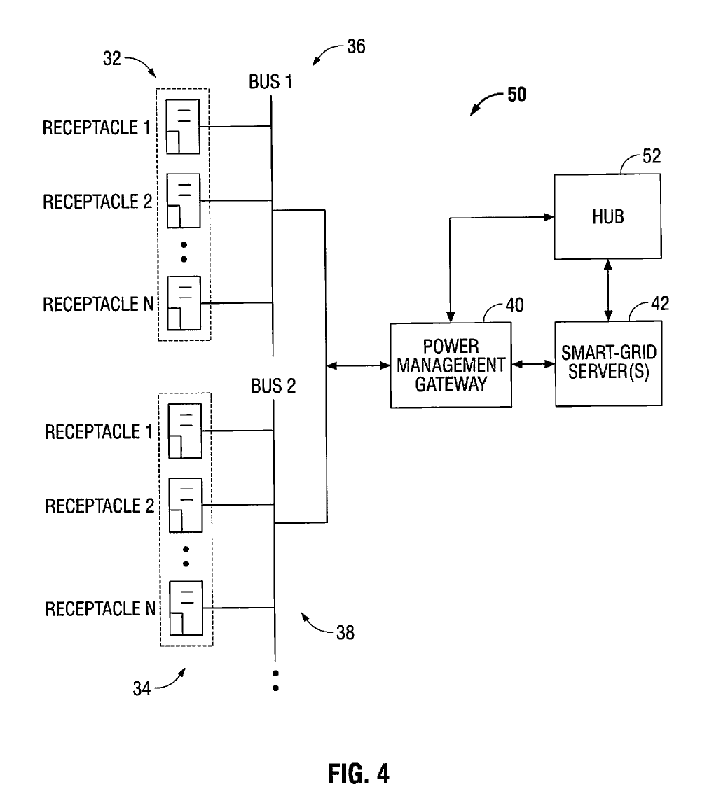

With reference to FIG. 4, there is presented a schematic diagram of a smart-grid power system including groups of receptacles and an external hub, in accordance with the second embodiment of the present disclosure.

The smart-grid power system 50 includes a first group of receptacles 32 connected to a first bus 36, a second group of receptacles 34 connected to a second bus 38, a power management gateway 40, a smart grid server 42, and an external hub 52. Smart grid power system 50 is similar to smart grid power system 20 and thus will only be discussed further herein to the extent necessary to describe differences in the construction and use thereof.

FIG. 4 merely illustrates a hub 52 that may be included in the smart-grid power system 30 of FIG. 3. The hub 52 has been described in detail with reference to FIG. 2 above.

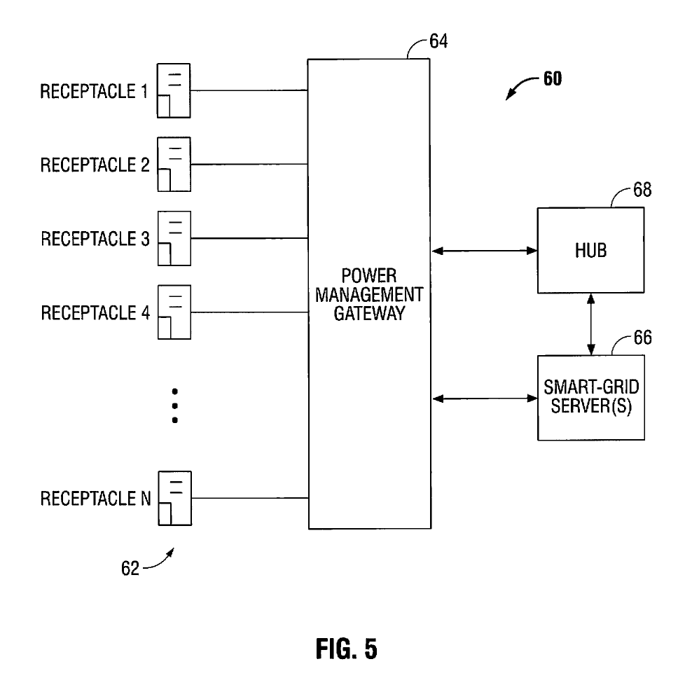

With reference to FIG. 5, there is presented a schematic diagram of a smart-grid power system where each of the plurality of receptacles is directly connected to a single power management gateway, in accordance with a third embodiment of the present disclosure.

The smart-grid power system 60 includes a plurality of receptacles 62, a power management gateway 64, a smart grid server 66, and an external hub 68. Smart grid power system 60 is similar to smart grid power systems 10, 20, 30, 50 and thus will only be discussed further herein to the extent necessary to describe differences in the construction and use thereof.

FIG. 5 merely illustrates that the plurality of receptacles 62 may be directly connected to the power management gateway 64. In other words, a shared communication line, such as a bus (see FIGS. 1-4) need not be included in the smart-grid power system 60. A bus may be included or excluded in accordance with power system requirements or configuration or implementations.

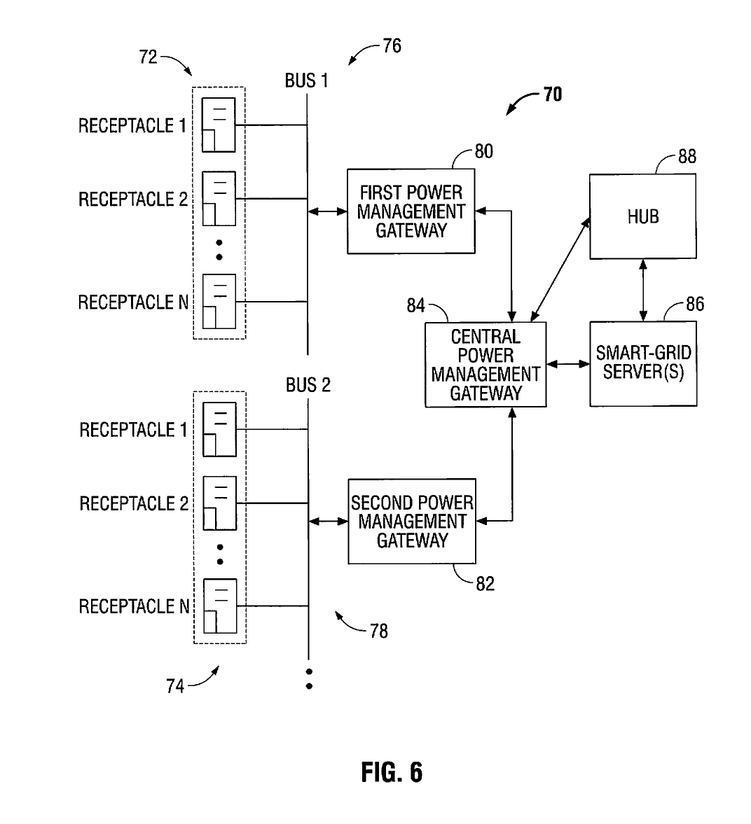

With reference to FIG. 6, there is presented a schematic diagram of a smart-grid power system where groups of receptacles are each connected to separate power management gateways for communication with a central power management gateway, in accordance with the present disclosure.

The smart-grid power system 70 includes a first group of receptacles 72 connected to a first bus 76 and a second group of receptacles 74 connected to a second bus 78. The first bus 76 is connected to a first power management gateway 80 and the second bus 78 is connected to a second power management gateway 82. The first power management gateway 80 and the second power management gateway 82 are connected to a central power management gateway 84, which in turn may be connected to a smart grid server 86 and a hub 88 (which is optional). Smart grid power system 70 is similar to smart grid power systems 10, 20, 30, 50, 60 and thus will only be discussed further herein to the extent necessary to describe differences in the construction and use thereof.

Such a configuration/implementation may be advantageous in a multi-level building structure, where, for example, a plurality of receptacles on each floor access a separate bus and a separate power management gateway, and the separate power management gateways connect to each other via a central power management gateway. Additionally, such configuration/implementation may be advantageous in a multi-home or multi-office environment, where, for example, a plurality of receptacles in each house or office accesses a separate power management gateway, and the separate power management gateways connect to each other via a central power management gateway. One skilled in the art may envision a number of different configurations/implementations where it would be advantageous to group a plurality of receptacles based on a number of criteria and to provide a number of power management gateways.

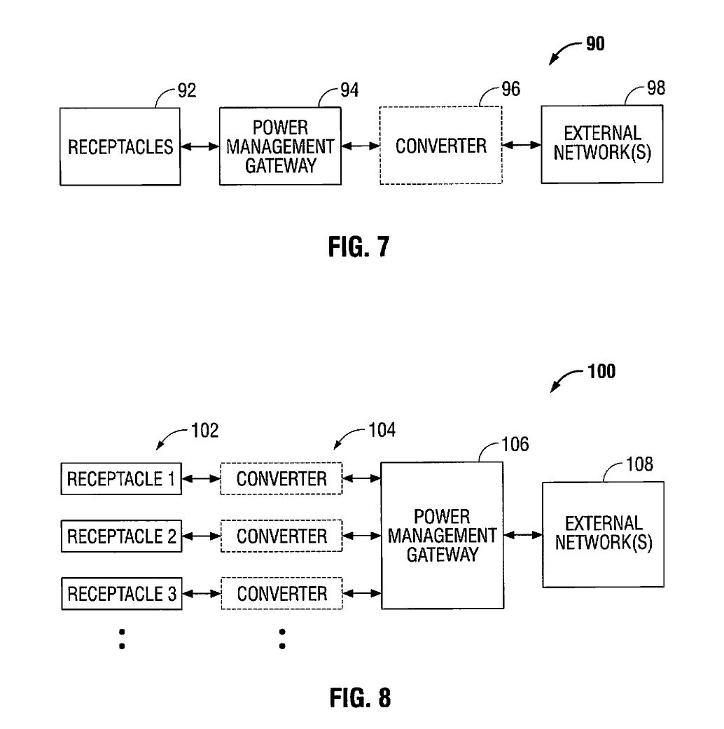

With reference to FIG. 7, there is presented a schematic diagram of a smart-grid communication system including a converter positioned between the power management gateway and one or more external networks, in accordance with the present disclosure.

The smart grid communication system 90 includes a plurality of receptacles 92, a power management gateway 94, a converter 96, and external network(s) 98.

As illustrated in FIG. 7, a converter 96 is positioned between the power management gateway 94 and the external network(s) 98. The converter 96 may convert a first signal received from the power management gateway 94 into a second signal transmitted to the external network(s) 98. The first signal may be a PLC signal and the second signal may be an Ethernet signal. Alternatively, the first signal and the second signal may be any types of signals contemplated by one skilled in the art. Additionally, a plurality of converters 96 may be positioned between a plurality of power management gateways 94 and the plurality of external networks 98. Each converter 96 of such a system may convert a first signal into a plurality of other signals for different external networks 98. In other words, a first signal may be converted to an Ethernet signal for a portion of the external networks 98 and the first signal may be converted to other different signals for other portions of the external networks 98.

With reference to FIG. 8, there is presented a schematic diagram of a smart-grid communication system including a plurality of converters positioned adjacent to each of the plurality of receptacles, in accordance with the present disclosure.

The smart grid communication system 100 includes a plurality of receptacles 102, a plurality of converters 104, a power management gateway 106, and external network(s) 108. Smart grid communication system 100 is similar to smart grid communication system 90 and thus will only be discussed further herein to the extent necessary to describe differences in the construction and use thereof.

In contrast to FIG. 7, each of the plurality of receptacles 102 is associated with a plurality of converters 104. In other words, each receptacle has its own converter. In addition, the plurality of converters 104 are positioned between the plurality of receptacles 102 and the power management gateway 106. Similarly, the PLC signals received by the plurality of converters 104 from the plurality of receptacles 102 are converted to, for example, Ethernet signals before they are received by the power management gateway 106. Once the power management gateway 106 receives the second signals (e.g., Ethernet signals), it may forward the second signals to the external networks 108 for further processing.

With reference to FIG. 9, there is presented a schematic diagram of a metered receptacle including a power sensor, a voltage sensor, and a microprocessor for communication with a power management gateway, in accordance with the present disclosure.

The metered receptacle 110 includes a first outlet 112, a second outlet 120, a current sensor 114, a voltage sensor 116, a microprocessor 118, and a connection to a power management gateway 122.

The sensors 114, 116 may be connected to the processor 118. Processor 118 controls the open/closed state of switches and uses predefined sensor-on-time/sensor-off-time values. For example, an on-off algorithm may be a simple predefined on-time/off-time alternating sequence. In an alternative embodiment, a separate sensor-controller, comprising a processor 118 and memory (not shown), may be used to control the sensors 114, 116.

For the preferred embodiment, processor 118 is configured to execute a sensor control program stored in at least one of memory (not shown) or some other memory associated with processor 118. Also stored in the memory are predefined sensor-off-time values, sensor-on-time value, and a delay value. It will be appreciated that each sensor 114, 116 may have its own sensor-off-time/sensor-on-time values or the sensors 114, 116 may use the same values and such values may be user programmable with limitations.

It should be appreciated that processor 118 may store processed or unprocessed sensor-signals in a memory associated with processor 118. Alternatively, processor 118 may simply route the sensor-signals to another electronic device. Alternatively, one skilled in the art may contemplate using a plurality of other sensors for measuring/monitoring/controlling a plurality of other desired variables/parameters.

With reference to FIG. 10, there is presented a schematic diagram of a metered receptacle including a power sensor, a voltage sensor, a microprocessor, a display screen, and a notification means for communication with a power management gateway, in accordance with the present disclosure.

The metered receptacle 130 includes a first outlet 112, a second outlet 120, a current sensor 114, a voltage sensor 116, a microprocessor 118, a connection to a power management gateway 122, a display screen 132, and a visual/audio notification 134. Power metered receptacle 130 is metered receptacle 110 and thus will only be discussed further herein to the extent necessary to describe differences in the construction and use thereof.

In FIG. 10, metered receptacle 130 further includes a display screen 132 and a visual/audio notification means 134.

The display screen 132 may display a number of different information to the user. Some information may include: power usage, wattage usage, percent of power usage with respect to other metered receptacles in the same room, percent of power usage with respect to other receptacles in a group of receptacles, percent of power usage with respect to other receptacles within the same structure (e.g., house, office, building, or separate floors within a building), usage per week, usage per month, usage per season (e.g., summer, winter), time-of-day usage, power received from alternative energy source, etc.

The visual/audio notification means 134 may be an audible signal or a lighting means (e.g., a light emitting diode (LED), or a plurality of LEDs) for notifying a user whether a specific meter receptacle 130 has exceeded an allowable or predefined/preset/predetermined power usage allotment. The power usage allotment may be set by an authorized power grid operator via the power management gateway 122 based on grid conditions. For example, a power grid operator (e.g., the owner of the home) may set a meter receptacle or a group of metered receptacles to consume only a certain number of watts per day, per night, per week, per month, per year, per season, per room, per floor, per office building, etc. The visual/audio notification means 134 may be automatic notifications based on one or more criteria and/or parameters preselected/predetermined/present by a user. The notification may be displayed on the display screen 132 or it may be transmitted to the power management gateway 122. In summary, the alerts may be visual alerts or audible alerts and may be transmitted to a user/administrator via any type of electronic means and may be logged (e.g., lists of alert/notification histories).

Moreover, a user may receive a notification while away from the power management gateway 122. In other words, a user may receive such a notification on a cell phone, handheld wireless device, PDA, PC, or any other portable electronic devices described above and remotely turn off (or otherwise control) one or more problematic receptacles. The power management gateway 122 may further have a built-in web-interface to enable electronic communication between itself and a plurality of portable electronic devices. In fact, each of the plurality of receptacles may have its own Internet Protocol (IP) address that is transmitted to the power management gateway 122 and from there to one or more portable electronic devices. Alternatively, a different IP address may be assigned to a group of receptacles or to a relay/bus connecting a specified number of receptacles.

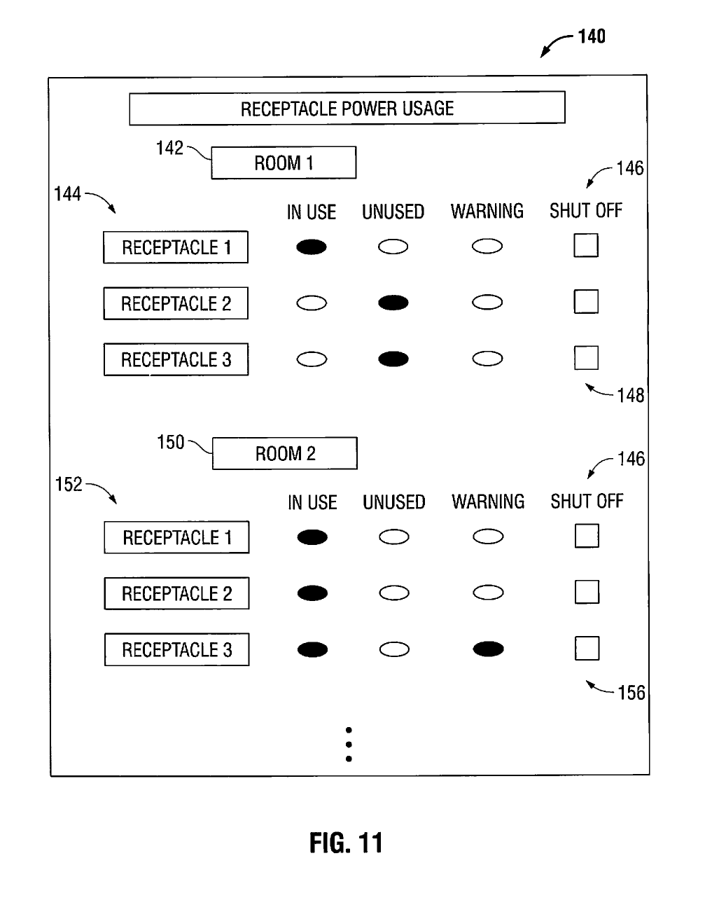

With reference to FIG. 11, there is presented a schematic diagram of a display screen of a power management gateway illustrating receptacle power usage, in accordance with the present disclosure.

FIG. 11 illustrates an exemplary display screen 140 of a power management gateway (e.g., 16, 40, 64, 80, 82, 84, 94, 106, 122 described above in FIGS. 1-10). One or more software applications may be developed to display such data/information on the display screen 140. A sample screen 140 may be entitled “receptacle power usage.”

The top section of the display screen 140 may include a first room 142 designation listing a plurality of first receptacles 144. A first title bar 146 may include the designations “in use,” “unused,” “warning,” and “shut off.” Underneath each designation may be a status menu 148 designating the status of each receptacle 144. For example, the first receptacle may be “in use,” whereas the second and third receptacles of the first room 142 may be “unused.”

The bottom portion of the display screen 140 may include a second room 150 designation listing a plurality of second receptacles 152. A second title bar 154 may include the designations “in use,” “unused,” “warning,” and “shut off.” Underneath each designation may be a status menu 156 designating the status of each receptacle 152. For example, all the receptacles 152 may be “in use,” whereas the third receptacle of the second room 150 may be in “warning” mode. In other words, the third receptacle may be drawing too much wattage or an excessive amount of wattage compared to other receptacles in that room or on that floor or in that house or office. Alternatively, one skilled in the art may contemplate a number of different criteria and/or parameters and/or values to monitor/measure/control and display on an exemplary display screen 140.

In another exemplary embodiment, with respect to the display screen 140 of FIG. 11, receptacles 144, 152 may be ranked by power usage or a plurality of other criteria. In an alternate embodiment, rather than give each of the plurality of receptacles 144, 152 a unique ranking, categories of importance may be established. In such an embodiment, several receptacles may have the same ranking. In this manner, in times of power shortage, individual power consuming devices may be turned off (manually or automatically) by a power grid operator based on grid conditions. A user may check the rankings every week or every month and receive an automatic alert/notification concerning the status of each and every metered receptacle in a house or office or building structure.

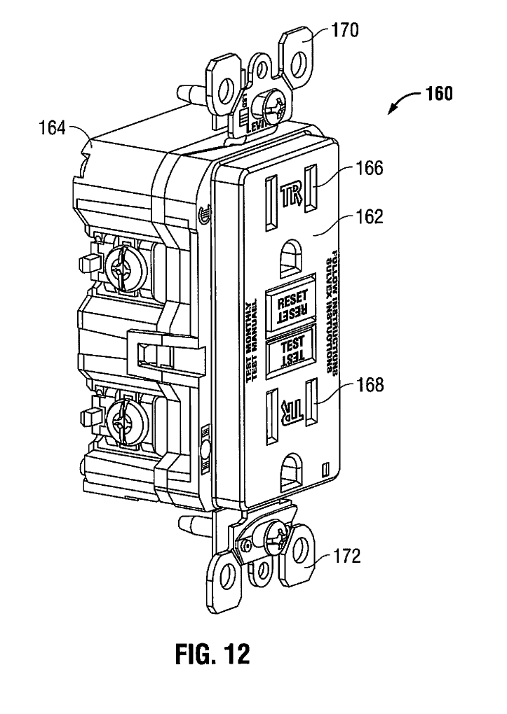

With reference to FIG. 12, there is presented a schematic diagram of 3-D view of a meter receptacle, in accordance with the present disclosure.

The 3-D view of the meter receptacle 160 includes a front plate 162, a back plate 164, a first outlet 166, a second outlet 168, a top mounting bracket 170, and a bottom mounting bracket 172.

A current sensor 114, a voltage sensor, 116, and a processor 118 described above with reference to FIGS. 9 and 10 are located within the meter receptacle 160 for measuring/monitoring/controlling a plurality of parameters/values, such as: the voltage present in the AC line, the AC current (amperage) that the load is consuming, the wattage (real power) that the load is consuming, the Volts-Amperes (apparent power) that the load is consuming, the power factor, and/or the kilowatt-hours that the load is consuming.

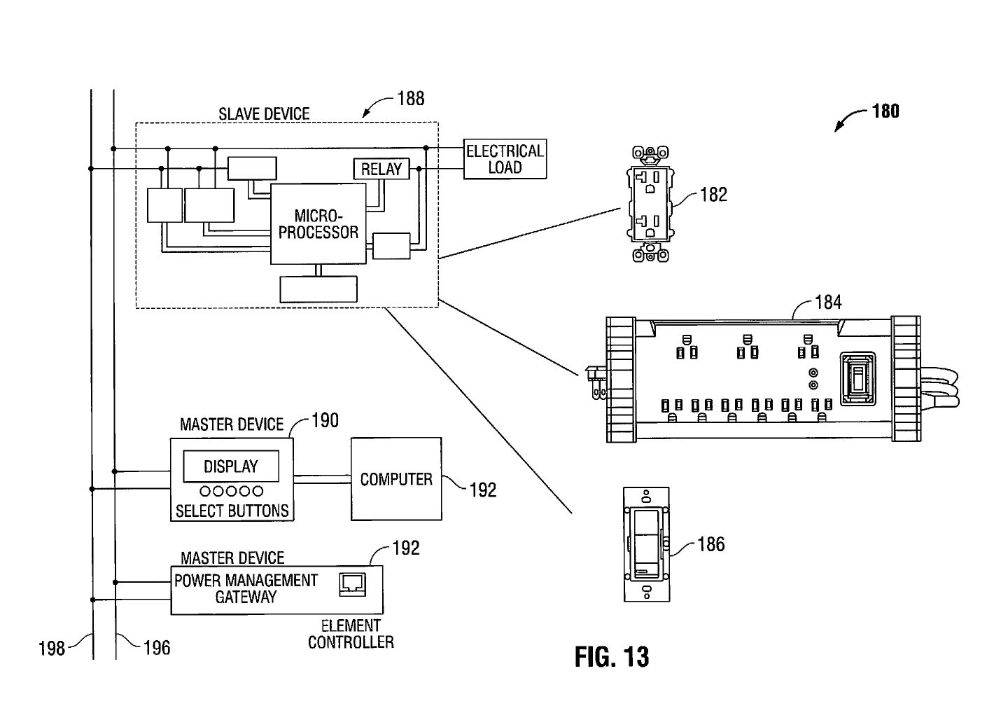

With reference to FIG. 13, a schematic diagram of a smart-grid power system including a power management gateway for managing and controlling one or more meter receptacles, in accordance with the present disclosure is presented.

FIG. 13 depicts a power system 180 including a receptacle 182, a power strip 184, a switch 186, a slave device 188, a master device 190, a computer 192, a power management gateway 194, a neutral line 196, and a hot line 198.

The slave device 188 may be connected to the receptacle 182, the power strip 184 and/or the switch 186. The master device 190 and the power management gateway 194 are connected to the neutral line 196 and the hot line 198. The master device 190 and the power management gateway 194 are further linked to the slave device 188 via the neutral line 196 and the hot line 198. FIG. 13 illustrates that the smart grid devices (i.e., the receptacle 182, the power strip 184 and/or the switch 186) need not be directly connected to the power management gateway 194.

FIG. 14 depicts a schematic diagram of a metered wireless microcircuit 200 incorporated with the one or more meter receptacles, in accordance with the present disclosure. The microcircuit 200 may be incorporated within the power module of each of the plurality of receptacles 12. For example, the product may include a small surface mount PCBA (printer circuit board assembly) with the microcircuit 200 that incorporates a built in meter, a main microcontroller, such as the PIC 24 from Microchip®, and a wireless module such as the ZeroG™ module from Microchip® for Wi-Fi and the Freescale™ ARM 7 microcontroller for the ZigBee wireless interface.

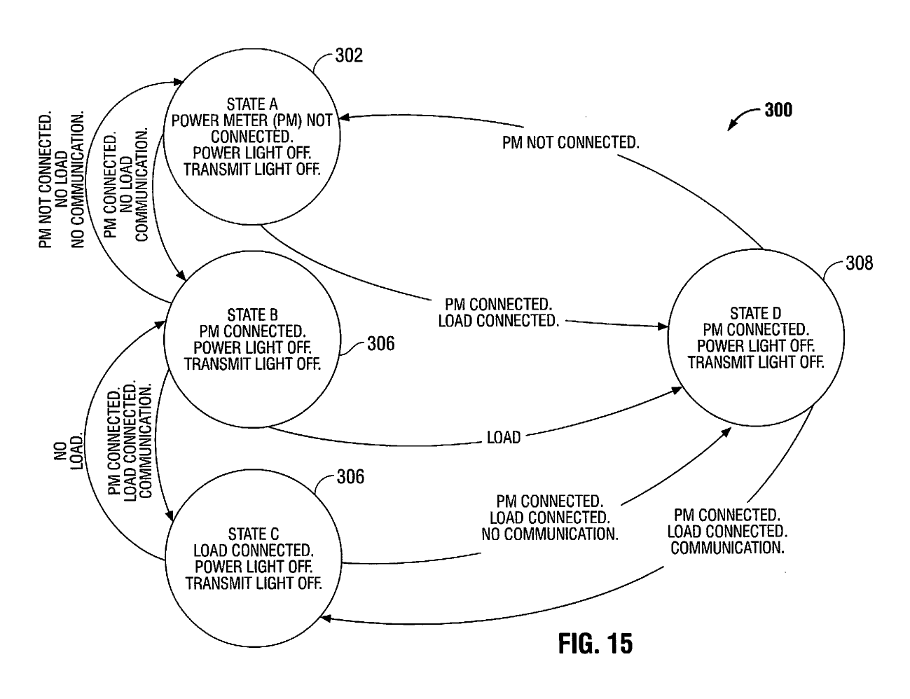

FIG. 15 depicts a state diagram 300 of a wireless meter receptacle. The state diagram 300 depicts four states. The first state 302 refers to a disconnected meter receptacle. The second state 304 refers to a connected meter receptacle. The third state 306 refers to a connected load. The fourth state 308 refers to a connected meter receptacle. One skilled in the art may contemplate a plurality of different states, each state based on a plurality of different variables.

Specifically, in the first state 302 the meter receptacle is disconnected, the power light is off and the transmit light is off. In the second state 304, the meter receptacle is connected, the power light is on and the transmit light is on. In the third state 306, the load is connected, the power light is on and the transmit light is on. In the fourth state 308, the meter receptacle is connected, the power light is on and the transmit light is off.

Between the first state 302 and the second state 304, when the meter receptacle is not connected and there is no load, there is no communication between such states. Between the first state 302 and the second state 304, when the meter receptacle is connected and there is no load, there is communication between such states.

Between the second state 304 and the third state 306, when the meter receptacle is connected and there is a load, there is communication between such states. Between the second state 304 and the third state 306, when there is no load, there is no communication.

Between the third state 306 and the fourth state 308, when the meter receptacle is connected and there is a load, there is no communication from the third state 306 to the fourth state 308. Between the third state 306 and the fourth state 308, when the meter receptacle is connected and there is a load, there is communication from the fourth state 308 to the third state 306.

Between the fourth state 308 and the first state 306, when the meter receptacle is not connected, there is no communication between such states. Between the fourth state 308 and the first state 306, when the meter receptacle is connected and there is a load, there is communication between such states.

Although the exemplary embodiments have been described as relating to Ethernet/IP-based data networks, the exemplary embodiments may be similarly applied to any type of data network. Furthermore, although packet networks are the most common for local area networks, the exemplary embodiments are not restricted to packet networks only, and may be applied to any digital data network, where network entities are identified uniquely by addresses.

Additionally, the smart grid networks of the exemplary embodiments may comprise one or more WAN networks and/or one or more LAN networks. At least one WAN module may be configured to communicate with a network operations center using standard WAN protocols, and unlicensed spectrum RF. At least one LAN module may be configured to communicate with local assets and resources using standard protocols such as, PLC, Ethernet, or RS-485. Alternatively, the smart grid gateway may be configured to permit service personnel/users/grid operators to run diagnostics, data recovery, and local software updates on the gateway via a LAN connection provided by the LAN module or via a WAN connection provided by the WAN module.

In summary, the present disclosure describes a system and method that provides for a smart electrical power distribution/monitoring/controlling smart grid by pushing intelligence and/or intelligent devices into the smart grid. In one embodiment, real time or periodic information may be provided to the point of consumption (i.e., receptacles). In another embodiment, the system allows for autonomous reactions to smart grid network events to optimize reliability and economics.

In another exemplary embodiment, one or more power/energy consumers may operate alternative source power generating devices. Possible power generating devices include, but are not limited to, solar units, wind turbines, geothermal units, fuel cells, biofuels, or exercise equipment. Power from the power generating devices may be supplied to the smart power grid. The receptacles and/or the power management gateways of the exemplary embodiments (e.g., 12, 16, 18, 22 of FIGS. 1 and 2) may be designed to compensate for such generated power. In other words, the receptacles may be designed to determine how much power is received from the utility company and how much power is generated by alternative energy sources. This mechanism enables a user or power grid operator of the power management gateways to adjust/modify/reconfigure power usage considerations and criteria/parameters/values.

In yet another exemplary embodiment, a hub or external networks or servers (e.g., 18, 22, 42, 52, 66, 68, 86, 88, 98, 108 as described in FIGS. 1-8 above) may send recommendations on saving power through changing usage patterns or suggesting conservation tips after measuring the power usage from each receptacle in a home or office or building structure or the like. In another example, the hubs or external networks or servers may provide feedback and other information to the user on environmental factors that result from consumer/user usage patterns and/or decisions.

In yet another exemplary embodiment, the smart grid system/network may include electronic storage, which may store historical usage and cost data related to each and every receptacle. The electronic storage may be located at the consumer site, the utility company, or a third party location (e.g., a service provider as described above with reference to FIG. 2). Furthermore, electronic storage may be located at some or all of these locations. With the historical data or information/historical usage patterns, the various entities associated with the smart grid system/network may perform statistical analysis and look for energy consumption trends. Analysis may show, for example, that a particular metered receptacle is in need of repair or replacement.

Moreover, in accordance with the exemplary embodiments, users are able to reduce the cost of power consumption (e.g., wattage) with minimal effort to set up and administer a system. Users may be able to measure the true costs of using devices on all the receptacles connected to or attempting to connect to the smart grid system. Users may also be able to implement power usage policies and/or rules for cost reduction. Users may also modify the system (e.g., via the power management gateways) by including a set of preset/predetermined/predefined defaults rules and/or policies that may be modified in any desirable manner based on cost reduction goals, cost recovery goals, and/or green initiatives. Users may further be able to measure, monitor, understand, and gain control over the costs and environmental impact of power usage in the home, office, or organization by analyzing, for example, wattage usage, and/or usage by home, floor, room, office, department, organization, and/or location.

Additionally, a number of software packages may be developed for the power management gateways to measure/monitor/control a plurality of receptacles and display data/information on a screen.

Consequently, the present disclosure provides many advantages. For example, the sensors (e.g., voltage and current sensors) built into the receptacles allow for remote monitoring/controlling or receiving of power consumption usage information. With the present disclosure, the user may input preferences for metered receptacles to be turned down or off (e.g., in case of a power shortage or based on individual usage preferences). An additional advantage is that instructions may be sent to the consumer/user/power grid operator from a remote location in order to realize increased energy efficiency. Furthermore, the consumer/user/power grid operator may be supplied with educational materials/information. Additionally, valuable historical power usage data may be gathered to aid the consumer/user/power grid operator and power utilities in planning for future power usage.

The present disclosure further provides a smart-grid communication system including a plurality of receptacles, one or more power management gateways in electrical communication with each of the plurality of receptacles, and one or more external communication sources. Each of the plurality of receptacles provides power usage information to the one or more power management gateways and to the one or more external communication sources.

The present disclosure further provides an electrical metered receptacle in electrical communication with a processor including a current sensor and a voltage sensor. The metered receptacle provides power usage information to one more external sources.

The present disclosure further provides a smart-grid communication system including a plurality of receptacles and a power management gateway in electrical communication with each of the plurality of receptacles. Each of the plurality of receptacles provides power usage information to the power management gateway. The power usage information is transmitted via a first communication means to the power management gateway and the power management gateway transmits the information via a second communication means to one or more external communications sources.

The present disclosure also includes as an additional embodiment a computer-readable medium which stores programmable instructions configured for being executed by at least one processor for performing the methods described herein according to the present disclosure. The computer-readable medium may include flash memory, CD-ROM, a hard drive, etc.

Although exemplary systems and methods have been described in language specific to structural features and/or methodological acts, it is to be understood that the subject matter defined in the present disclosure is not necessarily limited to the specific features or acts described. Rather, the specific features and acts are disclosed as exemplary forms of implementing the methods, devices, systems, etc. of the present disclosure. The abstract and the title are not to be construed as limiting the scope of the present disclosure, as their purpose is to enable the appropriate authorities, as well as the general public, to quickly determine the general nature of the present disclosure.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art.

1-50. (canceled)

51. A smart-grid communication system comprising:
a plurality of receptacles, each receptacle including a front plate, a back plate, at least one outlet, and a power module located within the receptacle; and
one or more power management gateways in bidirectional communication with the plurality of receptacles;
wherein the power module of each of the plurality of receptacles includes at least one sensor and a processor to collect and communicate energy consumption information to the one or more power management gateways.

52. The communication system according to claim 51, wherein the at least one sensor is configured for measuring current and voltage.

53. The communication system according to claim 51, wherein the processor is configured for collecting, analyzing, and communicating the energy consumption information.

54. The communication system according to claim 51, wherein the power module of each of the plurality of receptacles is configured to include notification means.

55. The communication system according to claim 51, wherein the power module of each of the plurality of receptacles is configured to measure and control electricity consumption.

56. The communication system according to claim 51, wherein the power module of each of the plurality of receptacles is configured to control at least one parameter selected from the following: voltage present in an AC line, AC current consumed by a load, wattage consumed by the load, apparent power consumed by the load, a power factor, and kilowatt-hours consumed by the load.

57. The communication system according to claim 51, wherein the one or more power management gateways are connected to one or more smart-grid servers, the one or more smart-grid servers being connected to one or more external smart hubs.

58. The communication system according to claim 51, wherein the one or more power management gateways are configured to be controlled by a single central power management gateway.

59. The communication system according to claim 51, wherein the plurality of receptacles are configured to be separated into a plurality of subsets, each subset collectively managed by the one or more power management gateways.

60. The communication system according to claim 51, further including a converter configured to enable communication between the one or more power management gateways and a plurality of networks.

61. The communication system according to claim 51, further including a converter configured to enable communication between the plurality of receptacles and the one or more power management gateways.

62. The communication system according to claim 51, wherein each of the one or more power management gateways is configured to rank the plurality of receptacles connected thereto based on at least one criterion.

63. The communication system according to claim 51, wherein external power generating devices are configured to provide power to the communication system, the communication system reconfigures power usage of the plurality of receptacles based on the amount of the external power received from the external power generating devices.

64. The communication system according to claim 51, wherein each of the plurality of receptacles is configured to be controlled from a remote location.

65. The communication system according to claim 51, wherein each of the plurality of receptacles is configured to be associated with an Internet Protocol (IP) address for bidirectional communication with the one or more power management gateways.

66. A receptacle comprising:
a front plate, a back plate, at least one outlet, a meter unit; and at least one sensor located within the receptacle for measuring an electrical usage parameter;
wherein the meter unit is configured to collect and communicate the measured electrical usage parameter to one or more power management gateways.

67. The receptacle according to claim 66, wherein the meter unit of the receptacle is configured for measuring current and voltage via the at least one sensor.

68. The receptacle according to claim 66, wherein the meter unit of the receptacle is configured to include a processor for collecting, analyzing, and communicating the energy consumption information.

69. The receptacle according to claim 66, wherein the meter unit of the receptacle is configured to measure and control electricity consumption.

70. The receptacle according to claim 66, wherein the meter unit of the receptacle is configured to control at least one parameter selected from the following: voltage present in an AC line, AC current consumed by a load, wattage consumed by the load, apparent power consumed by the load, a power factor, and kilowatt-hours consumed by the load.

71. The receptacle according to claim 66, wherein the receptacle includes a display unit for displaying information related to the receptacle in communication with the one or more power management gateways.

72. The receptacle according to claim 71, wherein the display unit includes one or more audio indicators, one or more visual indicators and/or a display screen.

73. The receptacle according to claim 66, wherein historical usage and cost data is extracted from a memory unit included in the receptacle.

74. The receptacle according to claim 66, wherein the receptacle is configured to be controlled from a remote location.
